(19) United States
(12) Patent Application Publication
(10) Pub. No.: US 2009/0287650 A1
(43) Pub. Date: Nov. 19, 2009

(54) MEDIA FILE SEARCHING BASED ON VOICE RECOGNITION

(75) Inventor: Sun Hwa Cha, Seoul (KR)

Correspondence Address: BIRCH STEWART KOLASCH & BIRCH, PO BOX 747, FALLS CHURCH, VA, 22040-0747, US

(73) Assignee: LG ELECTRONICS INC., Seoul (KR)

(21) Appl. No.: 12/306,538

(22) PCT Filed: Jun. 27, 2007
(86) PCT No.: PCT/KR2007/003119

§ 371 Date: Dec. 24, 2008

(30) Foreign Application Priority Data
Jun. 27, 2006 (KR) 10-2006-0057800

(51) Int. Cl. G06F 17/30

(52) U.S. Cl. 707/3; 707/E17.015

(57) ABSTRACT

Provided are a method for searching for media files on the basis of voice recognition and a mobile device for searching for media files based on voice recognition. The media files are stored in a storage unit. Keywords of the media files stored in the storage unit are extracted and stored in a keyword storage unit. The keywords are searched for on the basis of user voice recognition input to the mobile device, so that corresponding media files are searched for and output.

### TECHNICAL FIELD

The present disclosure relates to media file searching based on voice recognition.

### BACKGROUND ART

A mobile device that can reproduce a media file is provided. For example, a mobile communication terminal can reproduce a music file, a moving image file, an image file, and a document file. A user searches for a media file to reproduce the media file stored in the mobile device. The searching of the media file is performed according to a device manipulation command by the user. The user uses a keypad of a mobile device or a touch pad type device manipulation unit to search for a media file.

### DISCLOSURE OF INVENTION

### Technical Problem

Embodiments provide searching for a media file more conveniently and effectively in a mobile device.

### Technical Solution

The present disclosure provides a media file searching method based on voice recognition and a mobile device for searching for media files based on voice recognition.

In one embodiment, a method for searing for media files, the method includes: recognizing voice signals input to a mobile device; searching for media files on the basis of the recognized voice signals and a keyword of the media files stored in the mobile device; and outputting the searched media files.

In another embodiment, a method for searching for media files, the method includes: extracting keywords for media file searching based on voice recognition from the media files stored in a mobile device; recognizing voice signals input to the mobile device; searching for the media files on the basis of the recognized voice signals and the keyword; and outputting the searched media files.

In still further another embodiment, a mobile device includes: a storage unit for storing media files; a keyword storage unit for storing keywords of media files stored in the storage unit; a searching unit for searching for the keywords on the basis of user voice recognition input to the mobile device to search for corresponding media files; and an output unit for outputting the searched media files.

### ADVANTAGEOUS EFFECTS

According to an embodiment of this present disclosure, a media file including a music file (e.g., an MP3 file), a moving image file, and a document file stored in a mobile device can be effectively and conveniently searched for on the basis of voice signals input by a user. According to an embodiment of this present disclosure, a media file stored in a mobile device searched for on the basis of voice signals input by a user. A media file to be reproduced can be selected from the searched results on the basis of voice recognition, and the selected media file can be reproduced. According to an embodiment of the present disclosure, a portion of the searched media file is reproduced, so that the user can easily recognize a desired media file. Also, a media file from the searched results can be reproduced or searched for using voice commands such as “reproduction” and “next”.

### BRIEF DESCRIPTION OF THE DRAWINGS

FIG. 1 is a view illustrating the construction of a mobile device according to an embodiment of the present disclosure.

FIG. 2 is a view illustrating a method for searching for a media file according to an embodiment of the present disclosure.

### MODE FOR THE INVENTION

Embodiments will be described below with reference to the accompanying drawings.

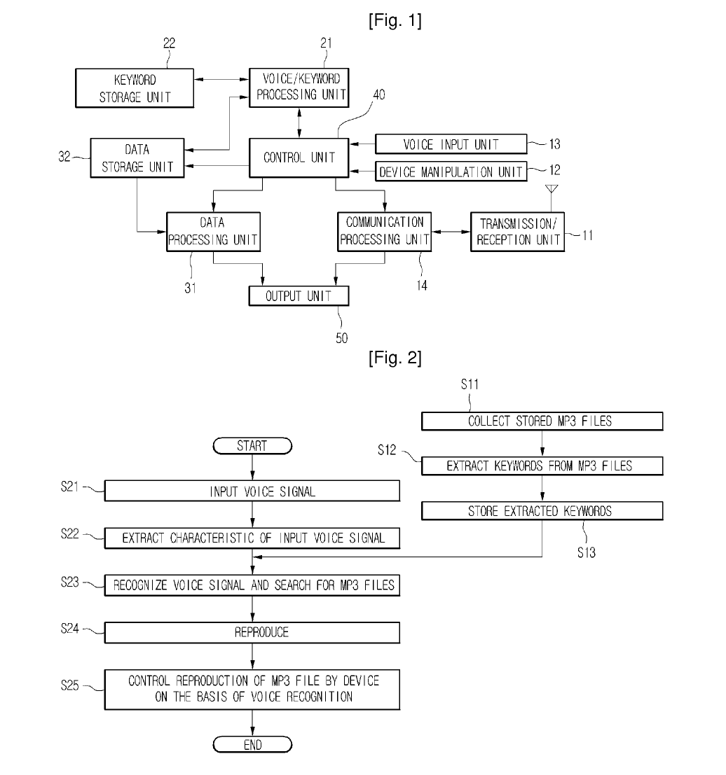

FIG. 1 is a view illustrating the construction of a mobile device according to an embodiment of the present disclosure.

The mobile device according to the embodiment includes: a device manipulation unit 12 for manipulating the mobile device; a voice input unit 13 for inputting voice signals of a user; a transmission/reception unit 11 for performing communication of voices and data on the basis of a mobile communication network; a communication processing unit 14 for transmission/reception processes of voice and data signals; a control unit 40 for performing a communication control, a voice recognition control, a media file processing control, and a device control; a voice/keyword processing unit 21 for recognizing input voice signals, extracting a keyword, and searching for a media file on the basis of a keyword; a keyword storage unit 22 for storing extracted keywords; a data storage unit 32 for storing a media file; a data processing unit 31 for reproducing a media file; and an output unit 50 for outputting a media file and a communication related signals.

The mobile device according to the embodiment searches for a media file on the basis of voice recognition, and outputs searched results. Examples of a media file may include a music file, a moving image file, an image file, and a document file, but the media file is not limited thereto. Embodiments describe the case where a music file of an MP3 format as a media file is searched for an output on the basis of voice recognition. It would be obvious to a person of ordinary skill in the art that the embodiments can be applied to other kind of media files. The embodiments are easily applied to searching of media files of other kinds such as music files of other than the MP3 format, moving image files, image files, document files.

The mobile device according to the embodiment is a mobile communication terminal including a function of storing and reproducing a music file. The device manipulation unit 12 can be a keypad or a touch pad type user interface unit. The control unit 40 controls the communication processing unit 14 according to a user command input through the device manipulation unit 12 to perform voice communication or data communication with the other party. The communication processing unit 14 performs coding or decoding of a voice or data signal, analog-to-digital conversion of a signal, or digital-to-analog conversion of a signal. The transmission/reception unit 11 converts a signal to be transmitted into a signal in a radio frequency band, and demodulates a radio signal received via an antenna to provide the demodulated signal to the communication processing unit 14.

The data storage unit 32 stores media files, for example, music files of an MP3 format according to the present embodiment. Various kinds of memory units can be used as the data storage unit 32. The data storage unit 32 can be mounted within the mobile device, or can be an external memory unit. For example, the data storage unit 32 can be a semiconductor memory unit such as a flash memory, and an optical recording medium. Also, the data storage unit 32 can be a disk type memory unit such as a hard disk drive (HDD). In the embodiment, a music file is downloaded to the data storage unit 32 using a wired/wireless communication unit. Also, in the case where the data storage unit 32 is an external memory, the music file is stored using other device excluding the mobile device. Even in case of other media files such as moving image files, image files, and document files, they are downloaded or stored in the external memory.

The voice/keyword processing unit 21 extracts keywords from music files stored in the data storage unit 32, and stores the extracted keywords in the keyword storage unit 22. A keyword that can be extracted from a music file can be at least one of a filename, a title, an album title, a singer name, a production date, a genre, and a lyrics. The title, the album title, the singer name, the production date, the genre, and the lyrics can be extracted from additional data of a music file. Since the additional data of the music file is based on an audio compression coding standard and the audio compression coding standard is based on a known standard, detailed description thereof will refer to related technology at a level of a person of ordinary skill in the art. In the embodiment, descriptions of a detailed format of a music file, a method for recording or extracting additional data, and a technique for extracting and recognizing additional data will be omitted.

A keyword can be extracted and stored in various points. For example, a keyword is extracted and stored in advance from a music file. Also, a keyword is extracted and stored at a point when a music file is stored in the data storage unit 32. In the case where the keyword is extracted and stored at the point when the music file is stored in the data storage unit 32, the keyword is extracted and stored at a point when the music file is stored in the data storage unit 32 using a wired/wireless communication unit, or at a point when an external memory (in case of the external memory) in which the music file has been stored is recognized by the control unit 40.

At least one keyword corresponds to one music file is stored in the keyword storage unit 22 by the voice/keyword processing unit 21. Link information that connects a keyword with a music file is required for searching for the music file corresponding to the keyword stored in the keyword storage unit 22. In this embodiment, the keyword storage unit 22 stores the connection data. For example, position data representing a position where one of music files stored in the data storage unit 32, that corresponds to a predetermined keyword has been stored can be used as the link information that connect the keyword with the music file. Also, a filename of a music file corresponding to a predetermined keyword can be used as the data that connect the keyword with the music file.

The voice input unit 13 can be a microphone. User voice signals input to the voice input unit 13 are delivered to the voice/keyword processing unit 21 under control of the control unit 40. The voice/keyword processing unit 21 recognizes the input user voice signals. The user voice signals recognized by the voice/keyword processing unit 21 serve as a query keyword. The voice/keyword processing unit 21 compares the query keyword with a keyword stored in the keyword storage unit 22. The comparison results are delivered as searching results to the control unit 40. For example, a keyword that is the same as or similar to recognized voice signals is searched for from the keyword storage unit 22, and the searched result is delivered to the control unit 40. The comparison result of the query keyword with the stored keyword is determined depending on similarity. For example, data of a music file corresponding to a keyword having similarity between the query keyword and the stored keyword that is greater than similarity value set in advance is delivered to the control unit 40.

The data of the music file delivered to the control unit 40 are connection data of the music file corresponding to the searched keyword. As described above, the connection data can be the storage position data of the corresponding music file stored in the data storage unit 32, or a filename of the music file. The control unit 40 can recognize what kind of file searching request is made by a user using music file data delivered from the voice/keyword processing unit 21. The control unit 40 reads corresponding music file data from the data storage unit 32, and outputs the read data to the output unit 50 via the data processing unit 31. The output unit 50 can be a voice output unit such as a speaker, a headset, and an earphone, or an image output unit. Also, both the voice output unit and the image output unit can be used.

It is considered that at least one file searched for on the basis of the voice recognition is provided. When there is no music file searching result on the basis of voice recognition, the control unit 40 can output a message saying no result in the form of a text and/or voice signals through the output unit 50. For outputting of searched results, a filename of a music file can be displayed through the image output unit or the music file can be reproduced using the voice output unit.

For a method for outputting a music file, searched music files can be sequentially reproduced or partial sections of the searched music files can be reproduced. In the case where only one music file has been searched for, that music file is reproduced or a partial section of that music file is reproduced. In the case where a plurality of music files have been searched for, the plurality of music files are reproduced automatically and sequentially, or partial sections of the respective music files are reproduced sequentially and automatically. Also, in the case where the plurality of music files have been searched for, a musical piece or a partial section of the musical piece on a next order or a previous order is selected and reproduced within searched results according to a searching command by a user. Here, the searching command for a musical piece within the searched results is input from the device manipulation unit 13, or can be a user voice command input via the voice input unit 13. The control unit 40 controls reproducing and outputting of a music file. A music file is read from the data storage unit 32, decoded, signal-converted, and reproduced through the data processing unit 31, and output through the output unit 50 under control of the control unit 40.

When a partial section of a music file is reproduced, the music file can be reproduced for twenty seconds staring from the beginning of the music file in terms of time. Various methods can be used as a method for reproducing a partial section of a searched music file. A user can designate a reproduction time or section using the device manipulation unit 12. The reproduction time or section can be determined by t he user or a device vendor. Data related to a type of reproducing a partial section of a music file are stored, which is performed by the control unit 40.

The data processing unit 31 reproduces a music file and delivers the reproduced music file to the output unit 50. Description will be made using a music file of an MP3 format. The data processing unit 31 decodes digital music data stored in the data storage unit 32, converts the decoded music data into analog signals, and outputs the converted analog signals via the output unit 50. A searched music file is reproduced according to a user command. To reproduce a music file, a user selects in person a music file to be reproduced using the device manipulation unit 12, and reproduce the selected music file. Also, when the user inputs a reproduction command using the voice input unit 13, a corresponding voice signal command is recognized by the voice/keyword processing unit 21, and a recognition result is delivered to the control unit 40, which reads a corresponding music file stored in the data storage unit 32 to reproduce the music file through the data processing unit 31 and the output unit 50. That is, device manipulation for reproducing a music file on the basis of voice recognition is performed.

When a plurality of searched results are output, the searched music file data can be decoded by the data processing unit 31 and displayed in the form of a list via the output unit 50. When the plurality of searched results are output, additional searching can be performed from the searched results within the searched results for the music files. To search for and reproduce a music file, a user can search for and select a music file in person using the device manipulation unit 12. Also, the music file can be searched for and selected according to a searching command using voice signals of the user. Regarding the searching and reproducing of the music file using the voice signals of the user, partial sections of the plurality of searched music files can be reproduced one by one whenever the searching command of the user is input. Also, partial sections of the plurality of searched music files can be reproduced sequentially and automatically.

The additional searching for the music file within the searched results can be performed using the device manipulation unit 12, or the voice input unit 13. A user inputs a voice command for searching, that is, a searching command. The command for searching within searched results can be performed by inputting a voice signal of ‘next’ or ‘previous’. The searching command input to the voice input unit 13 is recognized by the voice/keyword processing unit 21, and recognized results are delivered to the control unit 40. The control unit 40 outputs a music file on a next order or on a previous order according to the voice command. For example, in the case where a plurality of music files are provided as searched results, a portion of a music file on a next order is reproduced according to a searching command of ‘next’. When a searching command of ‘next’ is input while a portion of a music file is being reproduced, the control unit 40 controls the data processing unit 31 to suspense reproducing of the music file, a portion of which is currently reproduced, and to select and reproduce a music file on a next order. Since the music file, a portion of which is reproduced is heard to the user using voice signals through the output unit 50, the user can additionally search for a music file within the searched results using only a voice command, and can find a desired music file by listening to a portion of a searched music file in person. When there is a music file the user desires to listen to while searching for the music file is performed within searched results, and a voice signal of ‘reproduce’ is input to the voice input unit 13, the control unit 40 controls the data processing unit 31 to select and reproduce the music file to output the music file through the output unit 50.

FIG. 2 is a view illustrating a method for searching for a media file according to an embodiment of the present disclosure. The method for searching for the media file illustrated in FIG. 2 explains a method for searching for a music file of an MP3 format on the basis of voice recognition. This method is easily applied to searching for a music file of other format, and searching for a media file of other type such as a moving image file, an image file, a document file.

The voice/keyword processing unit 21 collects MP3 music files stored in the data storage unit 32 under control of the control unit 40 (S11). A music file is downloaded to the data storage unit 32 using a wired/wireless communication unit. Also, in the case where the data storage unit 32 is an external memory, the music file is stored using other device excluding the mobile device.

The voice/keyword processing unit 21 extracts keywords from the collected MP3 music files (S12). Here, the extracted keywords include a filename, a title, an album title, a singer name, a production date, a genre, and a lyrics. The extracted keywords are stored in the keyword storage unit 22 (S13). The extracted keywords are stored together with connection data of corresponding music files from which the keywords have been extracted. The connection data can include a music filename or data regarding position where a music file has been stored. A keyword can be extracted and stored at various points. For example, a keyword is extracted and stored for a music file in advance. Also, a keyword is extracted and stored at a point when a music file is stored in the data storage unit 32. In the case where the keyword is extracted and stored at the point when the music file is stored in the data storage unit 32, the keyword is extracted and stored at a point when the music file is stored in the data storage unit 32 using a wired/wireless communication unit, or at a point when an external memory (in case of the external memory) in which the music file has been stored is recognized by the control unit 40.

In the case where a music filename includes both a singer name and a title, the singer name and the title can be simply extracted as keywords. In the case where the title includes several words, respective words or combination of the words forming the title can be extracted as keywords. In the case where a production date, a genre, an album name, and a lyrics are provided as additional data to a music file, they can be extracted as keywords. The extracted keywords are stored in the keyword storage unit 22.

A user inputs voice signals through the voice input unit 13 (S21). The characteristics of the input voice signals are extracted by the voice/keyword processing unit 21 under control of the control unit 40 (S22). The voice/keyword processing unit 21 recognizes what kind of voice signal has been input using characteristic data of the extracted voice signals, searches for a corresponding keyword from the keyword storage unit 22 using the recognition result, and delivers connection data of an MP3 music file that corresponds to the searched keyword to the control unit 40. The control unit 40 searches for a corresponding music file from the data storage unit 32 using the connection data (S23).

The searched results are output to the output unit 50 through the data processing unit 31 under control of the control unit 40. The searched results can be displayed as a list on a screen of an image output device of the output unit 50 of a mobile device, and a portion of a searched music file is reproduced (S24). Reproduction of an MP3 music file from the searched results by the device is controlled on the basis of voice recognition (S25). The method described with reference to the embodiment of FIG. 1 is applied to control operations based on voice recognition such as searching, selecting, and reproducing a music file performed on the searched results.

According to the present disclosure, voice commands for searching for, selecting, and reproducing a media file can be performed using commands recorded by a user in advance. In the case where the voice/keyword processing unit 21 includes a voice recognition learning function, a predetermined voice command can be programmed to be connected to a predetermined control command of the device. When the predetermined voice command is recognized, a corresponding function can be performed.

Up to now, the present disclosure has described searching for a music file, for example, a music file of an MP3 format as an embodiment thereof. However, this embodiment is only one example of media file searching proposed by the present disclosure. The above-described searching for a music file according to the embodiment described with reference to FIGS. 1 and 2 is applied to searching for a media file of other type such as a moving image file, an image file, and a document file.

In case of searching for a moving image file, the data storage unit 32 stores moving image files. In case of searching for the moving image file, examples of a keyword can include a moving image filename, a title, a production date, a genre, a director, a producer, and an actor, which are data that can be obtained from additional data. The searched results can be displayed in the form of a list of moving image filenames, and simultaneously, partial sections of the moving image files can be reproduced. Reproduction of an image according to a corresponding voice command, searching for a next image according to a corresponding voice command, and reproduction of a partial section of a next image upon searching for the next image are performed.

In case of searching for an image file, the data storage unit 32 stores an image file. In case of the image file, examples of keywords include an image filename, a product ion date, a producer, and classification data that can be obtained from additional data. Searched results can be displayed in the form of a list of filenames of image files, or in the form of plurality of images. Reproduction of an image file according to a corresponding voice command, searching for a next image file according to a corresponding voice command, and reproduction of a selected image file are performed.

In case of searching for a document file, the data storage unit 32 stores document files. In case of the document file, examples of keywords include a filename, a production date, a producer, and file format data that can be obtained from additional data. Searched results can be displayed in the form of a list of filenames of document files. Searched results can be provided in the form of a list even in case of document files. A device mounting a voice synthesizing function can convert filenames of searched document files into voices and output the same. Likewise, additional searching for or reproducing a document file within searched results can be performed on the basis of voice recognition.

Also, the searching for a media file proposed by the present disclosure can be applied to the case where a plurality of different kinds of media files are stored, and searched for on the basis of voice recognition.

The preset disclosure has been described with reference to embodiments thereof. A person of ordinary skill in the art would realize other embodiments different from those in the detailed description of the present disclosure within the scope of the present disclosure. Here, the substantial scope of the present disclosure is determined by appended claims, and it should be construed that all differences that fall within a scope equivalent to the appended claims are included in the present disclosure.

### INDUSTRIAL APPLICABILITY

The present disclosure is applied to searching for a media file using voice recognition.

1. A method for searing for media files, the method comprising:
recognizing voice signals input to a mobile device;
searching for the media files on the basis of the recognized voice signals and keywords of the media files stored in the mobile device; and
outputting the searched media files.

2. The method according to claim 1, wherein the keywords are extracted and stored from the media files before the searching.

3. The method according to claim 1, wherein the keywords are extracted and stored at a point when the media files are stored in the mobile device.

4. The method according to claim 1, wherein the keywords are extracted and stored at a point when the media files are stored through a wired/wireless download operation, or at a point when a memory device storing the media files is recognized by the mobile device.

5. The method according to claim 1, wherein the media files are output on the basis of link information connecting the keywords with the media files.

6. The method according to claim 1, wherein the media files are output on the basis of the keywords and data regarding positions where the media files have been stored.

7. The method according to claim 1, wherein the keywords comprise filenames of the media files.

8. The method according to claim 1, wherein the keywords are extracted from additional data of the media files.

9. The method according to claim 1, wherein a list of the searched media files is displayed and output.

10. The method according to claim 1, wherein portions of the searched media files are reproduced and output.

11. A method for searching for media files, the method comprising:
extracting keywords for media file searching based on voice recognition from the media files stored in a mobile device;
recognizing voice signals input to the mobile device;
searching for the media files on the basis of the recognized voice signals and the keywords; and
outputting the searched media files.

12. The method according to claim 11, wherein the media files comprise at least one of a music file, a moving image file, an image file, and a document file.

13. The method according to claim 11, wherein the keywords comprise at least one of a filename, a title, an album name, a singer name, a production date, a genre, and a lyrics of a music file.

14. The method according to claim 11, wherein a list of the searched media files is displayed and output.

15. The method according to claim 11, wherein portions of the searched media files are reproduced and output.

16. The method according to claim 11, wherein reproducing the searched media files is performed on the basis of a recognition result for a reproduction command in a form of voice input by a user.

17. The method according to claim 11, further comprising searching for media files within the searched results on the basis of a recognition result for a user voice command.

18. A mobile device comprising:
a storage unit for storing media files;
a keyword storage unit for storing keywords of media files stored in the storage unit;
a searching unit for searching for the keywords on the basis of user voice recognition input to the mobile device to search for corresponding media files; and
an output unit for outputting the searched media files.

19. The mobile device according to claim 18, wherein the keywords are extracted from the media files and stored in the keyword storage unit.

20. The mobile device according to claim 18, wherein a list of the searched media files is displayed or portions of the searched media files are reproduced and output upon output of the searched media files.
